(19) United States
(12) Patent Application Publication
(10) Pub. No.: US 2010/0122309 A1
(43) Pub. Date: May 13, 2010

(54) COMMENT DELIVERY SERVER, TERMINAL DEVICE, COMMENT DELIVERY METHOD, COMMENT OUTPUT METHOD, AND RECORDING MEDIUM STORING COMMENT DELIVERY PROGRAM

(75) Inventors: Nobuo Kawakami, Tokyo (JP); Akihiko Koizuka, Koshigaya-shi (JP)

Correspondence Address: CANTOR COLBURN, LLP, 20 Church Street, 22nd Floor, Hartford, CT, 06103, US

(73) Assignee: DWANGO CO., LTD., Tokyo (JP)

(21) Appl. No.: 12/597,098

(22) PCT Filed: Apr. 23, 2008
(86) PCT No.: PCT/JP2008/057835

§ 371 Date: Oct. 22, 2009

(30) Foreign Application Priority Data
Apr. 27, 2007 (JP) 2007-120319

(51) Int. Cl. H04N 7/173

(52) U.S. Cl. 725/116

(57) ABSTRACT

There is provided a comment delivery server in a comment delivery system having: a video delivery server which delivers video data a comment delivery server which delivers comments relating to the video; and a terminal device, wherein the comment delivery server has: a conversion data storage section which stores conversion data which associates a comment targeted for conversion together with the comment obtained after the targeted comment has been converted; a receiving section which receives as comment information from the terminal device a comment and a comment attachment time which represents an elapsed video playback time at the point when the comment was attached; a determination section which refers to the conversion data storage section and determines whether or not a comment targeted for conversion is included in the comment information received by the receiving section; a comment conversion section which, when it is determined based on a determination result from the determination section that a comment targeted for conversion is included in the comment information received by the receiving section, refers to the conversion data storage section and converts the received comment into a post-conversion comment which corresponds to this comment; a comment information storage section which stores the comment information after it has been converted by the conversion section; and a comment delivery section which delivers the comment stored in the comment information storage section to the terminal device.

### TECHNICAL FIELD

The present invention relates to a comment delivery server which collects comments made by users and outputs the collected comments such that they correspond to an elapsed video playback time, and to a terminal device, a comment delivery method, a comment output method, and a recording medium on which a comment delivery program is stored.

Priority is claimed on Japanese Patent Application No. 2007-120319, filed Apr. 27, 2007, the contents of which are incorporated herein by reference.

### BACKGROUND ART

Conventionally, a system which displays comments made by a user about contents of videos such as, for example, a broadcast television program or the like such that the comments are synchronized with the videos, is known.

This type of system is disclosed, for example, in Patent document 1. In this system, as a result of comments about a particular scene from a television program being written by the terminals of users on a bulleting board relating to television programs or the like, it is possible for the users to share various comments about the same television program. Any user is able to freely make this type of comments.

[Patent document 1] Japanese Unexamined Patent Application, First Publication, (JP-A) No. 2002-290949

### DISCLOSURE OF THE INVENTION

### Problems to be Solved by the Invention

However, in a system of the above-described conventional technology, while a user is able to make comments freely, there is a possibility that comments will be written which have nothing whatsoever to do with the contents of the videos being viewed, or that totally inappropriate comments will be written. Consequently, the problem arises that particular users may in some cases no longer be able to enjoy the program they are viewing.

The present invention was conceived in view of the above described circumstances and it is an object thereof to provide a comment delivery server, and a terminal device, a comment delivery method, a comment output method, and a recording medium on which a comment delivery program is stored, which are able to change a portion of a comment to a different comment.

### Means for Solving the Problem

In order to solve the above described problems, the present invention provides a comment delivery server in a comment delivery system comprising a video delivery server which delivers video data, the comment delivery server which delivers comments relating to the video, and a terminal device, the comment delivery server comprising: a conversion data storage section which stores conversion data in which a comment targeted for conversion is associated with a converted comment obtained by converting the targeted comment; a receiving section which receives as comment information from the terminal device a comment and a comment attachment time which represents an elapsed video playback time at the point when the comment is attached; a determination section which determines whether or not the comment targeted for conversion is included in the comment information received by the receiving section in reference to the conversion data storage section; a comment conversion section which converts the comment included in the comment information received by the receiving section into the converted comment which corresponds to the comment targeted for conversion in reference to the conversion data storage section when it is determined based on a determination result of the determination section that the comment targeted for conversion is included in the received comment information; a comment information storage section which stores the comment information converted by the conversion section; and a comment delivery section which delivers the comment stored in the comment information storage section to the terminal device.

In the comment delivery server of the present invention, it is possible for the conversion data storage section to store different conversion data for each item of video delivered by the video delivery server.

In the comment delivery server of the present invention, it is also possible in the conversion data for the post-conversion comment to be any one of audio, a static image, video, and a program.

Moreover, the present invention provides a terminal device in a comment delivery system comprising a video delivery server which delivers video data, a comment delivery server which delivers comments relating to the video, and the terminal device, the terminal device comprising: a conversion data storage section which stores conversion data in which a comment targeted for conversion is associated with a converted comment obtained by converting the targeted comment; a receiving section which receives as comment information from the comment delivery server a comment and a comment attachment time which represents an elapsed video playback time at the point when the comment is attached; a determination section which determines whether or not the comment targeted for conversion is included in the comment information received by the receiving section in reference to the conversion data storage section; a comment conversion section which converts the comment included in the comment information received by the receiving section into the converted comment which corresponds to the comment targeted for conversion in reference to the conversion data storage section when it is determined based on a determination result of the determination section that the comment targeted for conversion is included in the received comment information; a comment information storage section which stores the comment information converted by the conversion section; and an output section which outputs the comment information stored in the comment information storage section in accordance with the comment attachment time included in the comment information so as to be synchronized with the elapsed video playback time of the video data.

In the terminal device of the present invention, it is possible for the conversion data storage section to store different conversion data for each item of video delivered by the video delivery server.

In the terminal device of the present invention, in the conversion data, it is also possible for the post-conversion comment to be any one of audio, a static image, video, and a program.

In the terminal device of the present invention, the comment delivery system may comprise a contents delivery server which delivers contents; the terminal device may comprise a download section which, when a download request which commands that a download be performed is included in the comment in the comment information stored in the comment information storage section, performs a download from the contents delivery server in accordance with the download request; and the output section may output as a comment the contents downloaded by the download section in accordance with the comment attachment time included in the comment information so as to be synchronized with the elapsed video playback time of the video data.

In the terminal device of the present invention, if the download of the contents which correspond to the relevant comment attachment time has not been completed by an elapsed playback time which corresponds to the comment attachment time of the video data, then it is also possible for the output section to output different contents from the contents which have not yet been completely downloaded.

Moreover, the present invention provides a comment delivery method in a comment delivery system comprising a video delivery server which delivers video data, a comment delivery server which delivers comments relating to the video, and a terminal device, the comment delivery method in the comment delivery server comprising: receiving as comment information from the terminal device a comment and a comment attachment time which represents an elapsed video playback time at the point when the comment is attached; in reference to a conversion data storage section which stores conversion data in which a comment targeted for conversion is associated with a converted comment obtained by converting the targeted comment, determining whether or not the comment targeted for conversion is included in the received comment information; converting the comment included in the received comment information into the converted comment which corresponds to the comment targeted for conversion in reference to the conversion data storage section when it is determined based on the determination result that the comment targeted for conversion is included in the received comment information; storing the converted comment information in a comment information storage section; and delivering the comment stored in the comment information storage section to the terminal device.

Moreover, the present invention provides a comment output method in a comment delivery system comprising a video delivery server which delivers video data, a comment delivery server which delivers comments relating to the video, and a terminal device, the comment output method in the terminal device comprising: receiving as comment information from the comment delivery server a comment and a comment attachment time which represents an elapsed video playback time at the point when the comment is attached; in reference to a conversion data storage section which stores conversion data in which a comment targeted for conversion is associated with a converted comment obtained by converting the targeted comment, determining whether or not the comment targeted for conversion is included in the received comment information; converting the comment included in the received comment information into the converted comment which corresponds to the comment targeted for conversion in reference to the conversion data storage section when it is determined based on the determination result that the comment targeted for conversion is included in the received comment information; storing the converted comment information in a comment information storage section; and outputting the comment information stored in the comment information storage section in accordance with the comment attachment time included in the comment information so as to be synchronized with the elapsed video playback time of the video data.

Moreover, the present invention provides a computer readable recording medium storing a program which causes to be executed on a computer of a comment delivery server of a comment delivery system comprising a video delivery server which delivers video data, the comment delivery server which delivers comments relating to the video, and a terminal device: a function of receiving as comment information from the terminal device a comment and a comment attachment time which represents an elapsed video playback time at the point when the comment is attached; in reference to a conversion data storage section which stores conversion data in which a comment targeted for conversion is associated with a converted comment obtained by converting the targeted comment, a function of determining whether or not the comment targeted for conversion is included in the received comment information; a function of converting the comment included in the received comment information into the converted comment which corresponds to the comment targeted for conversion in reference to the conversion data storage section when it is determined based on the determination result that the comment targeted for conversion is included in the received comment information; a function of storing the converted comment information in a comment information storage section; and a function of delivering the comment stored in the comment information storage section to the terminal device.

Moreover, the present invention provides a computer readable recording medium storing a program which causes to be executed on a computer of a terminal device of a comment delivery system comprising a video delivery server which delivers video data, a comment delivery server which delivers comments relating to the video, and the terminal device: a function of receiving as comment information from the comment delivery server a comment and a comment attachment time which represents an elapsed video playback time at the point when the comment is attached; in reference to a conversion data storage section which stores conversion data in which a comment targeted for conversion is associated with a converted comment obtained by converting the targeted comment, a function of determining whether or not the comment targeted for conversion is included in the received comment information; a function of converting the comment included in the received comment information into the converted comment which corresponds to the comment targeted for conversion in reference to the conversion data storage section when it is determined based on the determination result that the comment targeted for conversion is included in the received comment information; a function of storing the converted comment information in a comment information storage section; and a function of outputting the comment information stored in the comment information storage section in accordance with the comment attachment time included in the comment information so as to be synchronized with the elapsed video playback time of the video data.

### EFFECTS OF THE INVENTION

As described above, according to the present invention, when a comment is received which matches a previously registered comment, it is possible to change the received comment into a different comment. As a result, it is possible to change comments which are unrelated to the contents of the video or which are deemed to be inappropriate subject matter to different comments and then output the changed comments.

Furthermore, according to the invention, because a plurality of comments which may be the same can be changed into different comments in accordance with each video, it is possible to change comments into a comment appropriate to content which is unique to a video and then output the changed comment.

### BRIEF DESCRIPTION OF THE DRAWINGS

FIG. 1 is a conceptual view showing a comment delivery system according to an embodiment of this invention.

FIG. 2 is a block diagram showing a comment delivery server according to an embodiment of this invention.

FIG. 3 is a drawing showing an example of data which is stored in a comment information storage section in an embodiment of this invention.

FIG. 4 is a drawing showing an example of conversion data in an embodiment of this invention.

FIG. 5 is a block diagram illustrating a terminal device in an embodiment of this invention.

FIG. 6 is a drawing showing an example of information which is displayed on an output device in an embodiment of this invention.

FIG. 7 is a flowchart showing an operation of a comment delivery server in an embodiment of this invention.

FIG. 8 is a flowchart showing an operation of a terminal device in an embodiment of this invention.

FIG. 9 is a flowchart showing an operation of a comment delivery server in the second embodiment of this invention.

FIG. 10A is a drawing showing an example of a display screen on which comments and videos are displayed in an embodiment of this invention.

FIG. 10B is a drawing showing another example of a display screen on which comments and videos are displayed in an embodiment of this invention.

FIG. 10C is a drawing showing another example of a display screen on which comments and videos are displayed in an embodiment of this invention.

FIG. 10D is a drawing showing another example of a display screen on which comments and videos are displayed in an embodiment of this invention.

FIG. 11 is a block diagram illustrating the structure of a terminal device in another embodiment of this invention.

FIG. 12 is a flowchart showing an operation of a terminal device in another embodiment of this invention.

### REFERENCE SYMBOLS

1 Video delivery server
2 Comment delivery server
3 Terminal device
5 Contents delivery device
21, 313 Comment information storage section
22 Communication section
23, 324 Conversion data storage section
24, 325 Determination section
25, 326 Comment conversion section
26 Comment information control section
27 Comment information delivery section
311 Video playback section
312 Receiving section
314 Output device
315 First output section
316 Second output section
317 Input section
318 Selection section
319 Playback control section
320 List storage section
321 Download section
322 Contents storage section
323 Transmitting section

### BEST MODE FOR CARRYING OUT THE INVENTION

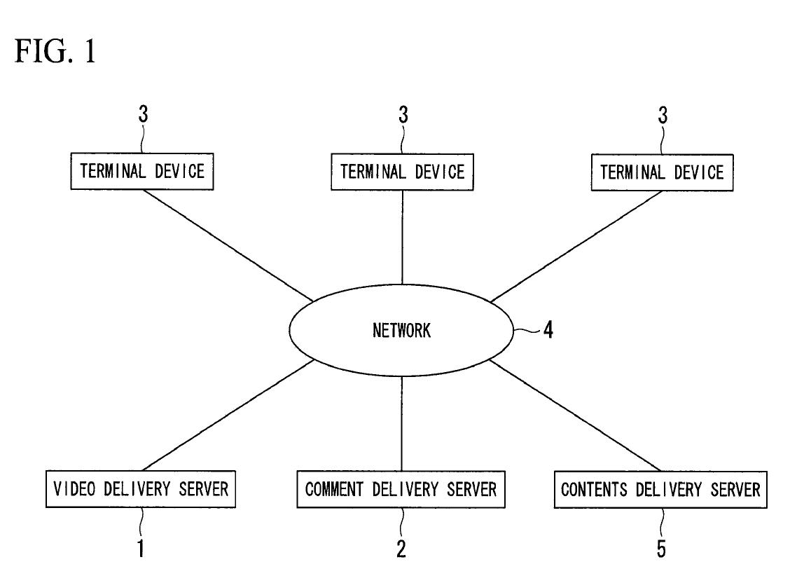

A comment delivery system according to a first embodiment of the present invention will now be described with reference made to the drawings. FIG. 1 is a conceptual view showing the structure of a comment delivery system according to an embodiment of this invention. FIG. 1 shows a comment delivery system in which a video delivery server 1, a comment delivery server 2, terminal devices 3, and a contents delivery server 5 are connected together via a network 4. The video delivery server 1 delivers video data in response to delivery requests from the terminal devices 3. Such deliveries are performed, for example, by streaming.

The comment delivery server 2 receives comments relating to videos delivered by the video delivery server 1 from the terminal devices 3, and delivers the received comments to each of the terminal devices 3 which is accessing those videos. This comment delivery server 2 has a function of changing comments which match predetermined conditions from among the comments transmitted from the terminal devices 3 to different comments, and then delivering these to other terminal devices 3.

The terminal devices 3 are able to be connected to the video delivery server 1, the comment delivery server 2, and the contents delivery server 5 via the network 4, and receive and display videos delivered from the video delivery server 1. In addition, the terminal devices 3 receive comments delivered from the comment delivery server 2 and, when the received comments are in text form, output them on videos being displayed on a display device.

When the received comments are contents, the terminal devices 3 download the contents from the contents delivery server 5 and either store them within the terminal device 3 or output these contents. When the contents are in the form of images, this output is displayed using a display device, while when the contents are in the form of audio, the contents are output suing an audio output device. Here, examples of audio contents include music and sound effects.

Various devices may be used as the terminal devices 3 provided that they have a function of displaying images, or a function of outputting audio and examples thereof include PCs, mobile telephones, PDA, and portable game devices and the like.

The contents delivery server 5 delivers contents which enable comments to be made about video data. Examples of these contents include videos, still pictures, photographs, illustrations, animations, music, sound effects, programs, and the like.

Next, the comment delivery server 2 and the terminal device 3 shown in FIG. 1 will be further described using the drawings.

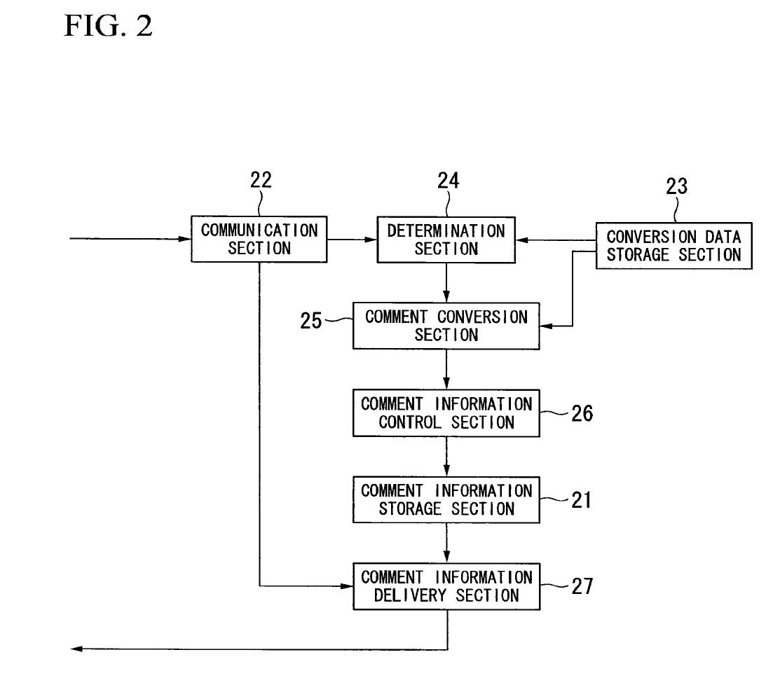

FIG. 2 is a schematic block diagram showing the structure of the comment delivery server 2. In this drawing, a comment information storage section 21 stores information relating to attached (i.e., issued) comments as comment information.

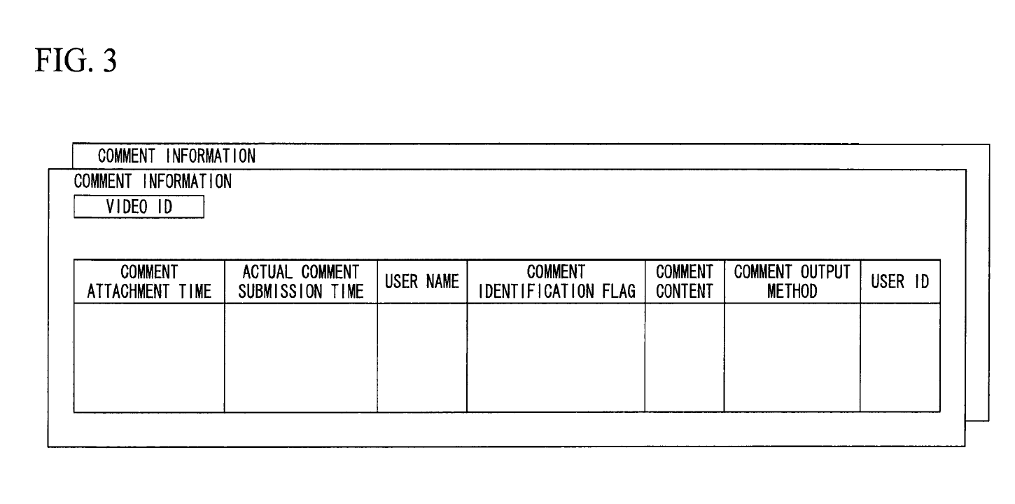

An example of information which is stored in this comment information storage section 21 is shown in FIG. 3. A plurality of groups of comment information obtained by grouping comments on videos delivered by the video delivery server 1 into their respective threads are stored as comment information in the comment information storage section 21. Each group of comment information includes video ID information which identifies the videos, and makes it possible to identify which video a thread belongs to. The comment information includes at least one item of comment data. In addition to the comment attachment time and the comment contents, this comment data includes the actual comment submission time which represents the actual time when a comment was attached (i.e., issued), the user name which is the name of the user who attached the comment, a comment identification flag which is used to identify whether the comment contents are in the form of text or contents, the comment output method which is information specifying how the comments are to be output on the screen of the terminal device or on an audio output device, and a user ID (corresponding to user identification information) which is information identifying the user who attached the comment.

When the videos of the relevant video ID are being played back, and comment data is received from a terminal device 3 which is accessing comments relating to this video ID, the comment data is additionally saved in the comment information. Note that in the present embodiment, the actual comment submission time is not included in the comment data transmitted from the terminal device 3, and the time when the comment delivery server 2 receives the comment data is used for the actual comment submission time, and is added to the comment data and additionally saved in the comment information. As a variant of this, it is also possible for a time when a comment was attached (i.e., issued) to be set as the actual comment submission time in the terminal devices 3, and for comment data which includes this to be transmitted to the comment delivery server 2.

The user name is a name which can be displayed on-screen as the person who has made a comment and, for example, may be set by the user actually making the comment.

When the comment identification flag is, for example, [0], this shows that the comment contents are in the form of text, while when the comment identification flag is [1], this shows that the comment contents are in the form of contents.

When the comments are text comments, the text data thereof is stored in the comment contents. When the comments are contents, the content name which is the name of the contents displayed on a contents list, and the contents identification information thereof are included in the comment contents. When the contents identification information are, for example, an 8-digit character string, then a portion of that character string may be used to identify whether the contents are in the form of video, audio, or a program.

When the comment is contents and these contents are in the form of video, the comment output method allows the size of the videos, the display position, the direction of movement, the movement speed and the like to be set. When the contents are in the form of audio, then the comment output method allows the volume and audio broadcast time and the like to be set.

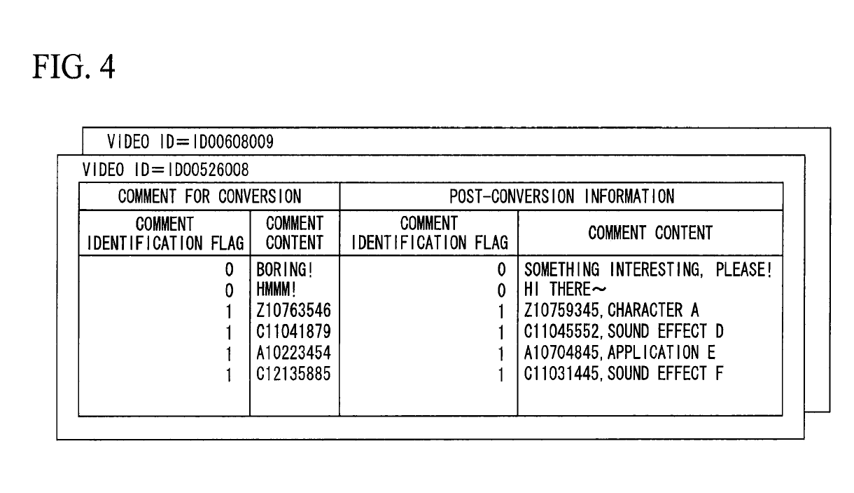

In FIG. 2, the communication section 22 receives comment attachment times which represent the elapsed video playback time at the point in time when a comment transmitted from a terminal device 3 was attached, user names, comment identification flags, comment contents, comment output methods, and user IDs. The conversion data storage section 23 stores conversion data in which comments targeted for conversion are associated with the comments obtained after the targeted comments have been converted. An example of this conversion data is shown in FIG. 4. Here, the conversion data is assigned to a video ID delivered by the video delivery server, and different conversion data is stored for each video ID. Comments targeted for conversion are associated with post-conversion information, and these are stored in this conversion data. A comment identification flag which shows whether the comments targeted for conversion are in text form or are in contents form is associated with the comment contents, and these are stored in the comments targeted for conversion. Contents identification information for the text targeted for conversion or for the contents targeted for conversion is stored in this comment contents. A comment identification flag which shows whether the post-conversion comments are in text form or are in contents form is associated with the comment contents, and these are stored in the post-conversion information. When the post-conversion comments are in text form, the post-conversion text is stored in the comment contents, while when the post-conversion comments are in contents form, contents identification information showing the post-conversion contents and a contents name are stored in the comment contents.

Accordingly, when a particular text is issued as a comment, there is a possibility that this comment will be converted into a different text. Moreover, when the name of a character related to the video is issued as a comment, there is a possibility that this comment will be converted into an illustration, image, video, information or the like of this character. When the name of an audio file is issued as a comment, it is possible that an audio file which is used to output the audio which corresponds to the name of this audio file will be played, while when the name of an application is issued as a comment, there is a possibility that a program which corresponds to the name of this application will be executed on top of a video. Here, contents identification information for the relevant contents of an audio file, image data, program or the like is stored as a post-conversion comment, and if this specific comment is issued, then it is possible to download the contents from the contents delivery server 5 using the contents identification information which corresponds to the issued comment. Moreover, it is also possible to store the URL (uniform resource locator) where the contents are stored as a post-conversion comment, and to download the contents from the specific URL.

When contents are issued as a comment, there is a possibility that this comment will be converted into different contents or text.

It is also possible for the conversion data to be conversion data which is common to all of the video IDs, and for the conversion data to be a combination of conversion data which is common to all videos and conversion data which is different for each video ID.

Moreover, it is also possible to refer to the comment identification flag of an issued comment, and to identify whether the contents of the issued comment were input in text form or were input in context form. Using the result of this identification, it is possible to determine whether or not the issued comment is a comment targeted for conversion by referring to the conversion data.

The determination section 24 refers to the conversion data storage section 23, and refers to comment contents of comment data received by the communication section 22 to determine whether or not comments targeted for conversion are included therein.

Based on determination results from the determination section 24, when it is determined that comments targeted for conversion are included in the comment data received by the communication section 22, the comment conversion section 25 refers to the conversion data storage section 23 concerning the received comments, and outputs to the comment information control section 26 comment data which has been converted into a post-conversion comment which corresponds to the received comment. When it is determined that comments targeted for conversion are not included in the comment information received by the communication section 22, comment conversion is not performed, and the comment data is output to the comment information control section 26.

The comment information storage section 26 stores comment data output from the comment conversion section 25 as comment information in the comment information storage section 21. The comment information delivery section 27 delivers to the terminal devices 3 comment information stored in the comment information storage section 21 in accordance with commands from the communication section 22.

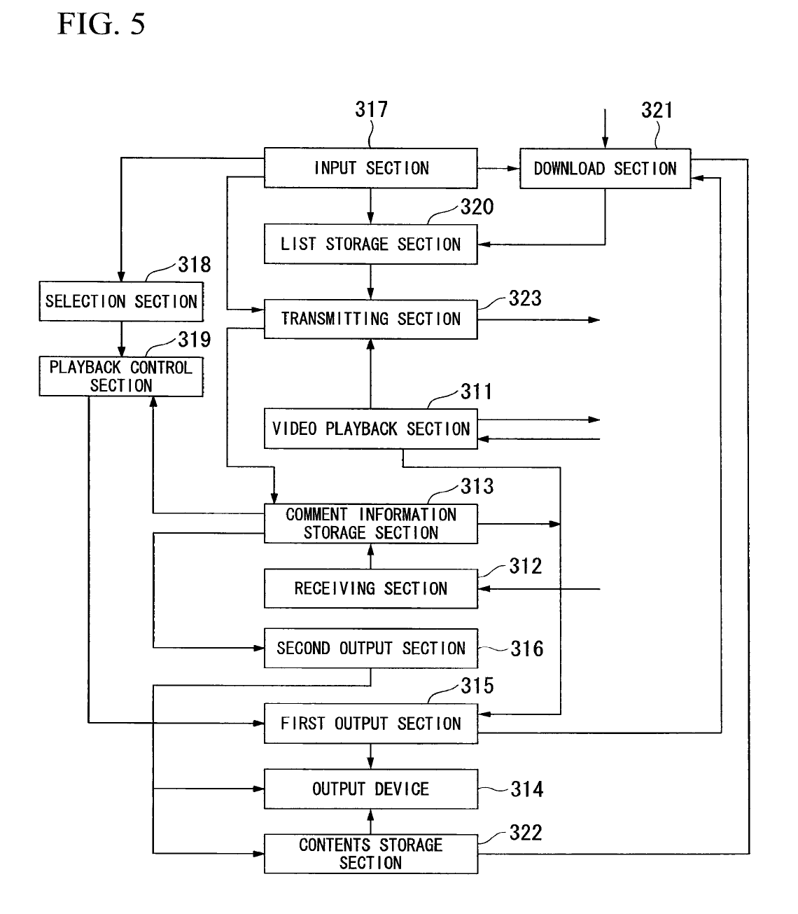

Next, a description will be given of a terminal device 3 using the drawings. FIG. 5 is a schematic block diagram illustrating the structure of a terminal device 3.

In FIG. 5, a video playback section 311 transmits a delivery request for videos specified by a user of a terminal device 3 to the video delivery server 1, and receives and then plays the videos delivered from the video delivery server 1. A receiving section 312 receives comment information input for the videos to be played back from the comment delivery server 2. A comment information storage section 313 stores comment information received by the receiving section 312.

An output device 314 is a liquid crystal display device or CRT (Cathode Ray Tube), or an audio output device such as speakers or the like, and outputs various types of information via these devices.

A first output section 315 acquires an elapsed video playback time for the videos being played from the video playback section 311. In conjunction with this, the first output section 315 reads from the comment information storage section 313 comment data to which has been assigned a comment attachment time corresponding to the elapsed video playback time for the acquired videos from the comment information stored in the comment information storage section 313, and outputs comments in the read comment data using the output device 314.

In addition, when contents corresponding to the contents identification information included in the comment data stored in the comment information storage section 313 are not stored in the contents storage section 322 (described below), the first output section 315 causes contents corresponding to this contents identification information to be downloaded from the contents delivery server 5 by the download section 321.

Moreover, if, at an elapsed playback time which corresponds to a comment attachment time in the video data, a download of contents corresponding to this comment attachment time has not been completed, the first output section 315 outputs contents which are different from the contents being downloaded as substitute contents. These substitute contents may be determined in advance, or may be selected at random from among pre-registered contents and then output.

A second output section 316 displays a list of comments on a display screen of the output device 314 based on comment data stored in the comment information storage section 313. Here, the list of comments is displayed in accordance with the sequence of the information on the actual comment submission time included in the comment data.

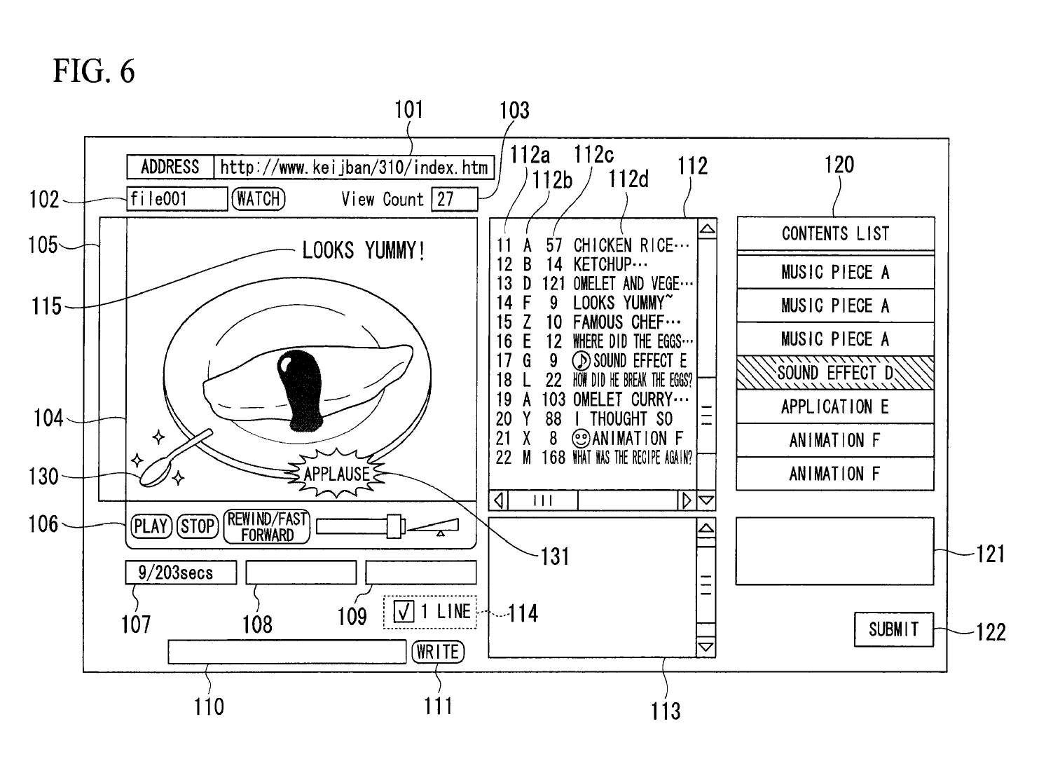

The information displayed on this output device 314 will now be described further. FIG. 6 shows an example of information which is displayed on the output device 314. A display box 101 is where a URL (uniform resource locator) is displayed when it has accessed this comment delivery server 2. A display box 102 is where the video ID of the videos being played is displayed. A display box 103 is where the total number of times that access to the videos currently being displayed has been requested is displayed as a view count. In this view count, when another user plays the videos (i.e., makes an access request), the count number of users currently viewing the same videos at that point increases, and the count number is updated and displayed. A display box 104 is where videos being displayed by the first output section are displayed. A display box 105 is an area where each comment from the list of comments displayed by the second output section is displayed in sequence in accordance with the comment attachment time, and, here, the comments are displayed on top of the videos displayed in the display box 104. Moreover, here, the display box 105 is set to a larger size than the display box 104, and comments and the like which are displayed in overlay are trimmed on the outer side of the display screen of the videos, so that it is possible to ascertain that the comments themselves are not included as part of the videos, but have been written by a user on top of the videos.

A play button, a stop button, a rewind button, a fast forward button, a volume adjustment button, a playback state display box which shows which portion of the overall video is currently being played and the like are displayed on an operating panel 106. By positioning a cursor over any of these buttons using a mouse and then clicking the mouse, input is received for an operation corresponding to that button. The length of playback time of the total video and the elapsed video playback time of the video currently being displayed in the display box 104 are displayed in a display box 107. The name of a user currently making a comment about a video is input into an input box 108 via an input section 317. Here, a check box is provided adjacent to the input box 108 and, by checking or not checking this check box, a user can select whether to input or not input their email address. When this check box has been checked, the input box 108 is divided into two boxes one of which receives the input of the user name, and the other of which receives the input of the user's email address. Information about comment output methods which specifies the method by which a text comment to be input into an input box 110 is to be output is input into an input box 109. Ways of making outputs which correspond to these comment output methods can be set as information specifying how a comment is to be displayed in overlay, for example, for the position at which a text comment is displayed on a video, and also for the font, the character size, the start position, end position, and movement direction of a moving comment, and the like. Note that, here, the method used to output a comment can also be decided in advance so that the user does not have to make any input themselves.

Text-based comments are input into an input box 110 by a user via the input section 317. When a button 111 is clicked, the text-based comments input into the comment box 110, as well as the name of the user which has been input into the input box 108 and information about how the comment is to be displayed which has been input into the input box 109, the comment identification flag for the contents which shows that the comment is text, the comment attachment time, the video ID, and the user ID are transmitted to the comment delivery server 2. A display box 112 is an area where a list of comments is displayed. In this list of comments are displayed numbers showing the comment sequence which is attached to the comments (112a), the names of the users who input the comments (112b), comment attachment times representing when the comments were written (112c), and the first portion of each comment (112d) in accordance with the sequence of the information for the actual time when they were submitted. An input box such as a check box or the like for specifying whether or not to display this display box 112 on the screen is provided adjacent to the display box 112 so that it is possible to either display or hide the display box 112 in accordance with a command to display or not display which is input into this input box. Moreover, it is also possible for the number of the comment portions which are displayed in the display box 112 to be altered in accordance with a command from the user. Of these comment portions (112d) displayed in the display box 112, when the comment is in the form of contents, a mark showing that the comment is in the form of contents and the title of the contents are displayed. Depending on whether or not this mark is displayed, it is possible to ascertain whether text is to be displayed or whether contents are to be output. The displayed mark may be changed in accordance with whether the contents are classified as video or audio.

A display box 113 is where details of those comments from among the list of comments displayed in the display box 112 over which the cursor has been placed by the user are displayed. Comment details may include the entire comment text, and the name and email address and the like of the user who made the comment.

A check box 114 is used to specify that one line of each comment input into the comment box 110 is displayed, and does so when a check mark is input therein. For example, if a check mark is input into the check box 114 and the inputting of a comment is completed, and a command is input that inputting has been completed, for example, by pressing the enter key or the like, then at the moment that the enter key is pressed, the “write” button is taken as having been clicked, and the comment is transmitted to the comment delivery server 2. As a result, it is possible to easily and quickly input a comment.

A display box 120 is an area where a list of contents about which a user is permitted to make comments is displayed as a contents list.

An input box 121 is where information is input about the comment output method which specifies the output method for contents selected from the contents list in the display box 120. For example, when the contents are in the form of video, it is possible to input the size of the video, the display position, the direction of movement, the speed of movement and the like. When the contents are audio, then it is possible to input the volume and audio broadcast time and the like. Note that, here, the method used to output a comment can also be decided in advance so that the user does not have to make any input themselves.

When a button 122 is clicked, the contents identification information for the contents selected in the input box 120, as well as the name of the user which has been input into the input box 108, the comment output method input into the input box 122, the comment identification flag for the contents which shows that the comment is contents, the comment attachment time, the video ID, and the user ID are transmitted to the comment delivery server 2.

Next, returning to FIG. 5, the input section 317 is an input device such as a mouse or keyboard and receives inputs of various types of information from a user. When the terminal device 3 is a portable type of electronic instrument, then a ten-key or input buttons function as the input section 317. This input section 317 has a function of receiving the data input of selection commands to select contents issued by users as comments from contents stored in a list storage section 320 (described below). A selection section 318 receives inputs of selections of comments which are input via the input section 317 from the list of comments displayed by the second display unit 316. A playback control section 319 reads from the comment information storage section 313 comment data for comments selected by the selection section 318, and causes video to be played by the video playback section 311 from the elapsed video playback time which corresponds to the comment attachment time in the read comment data.

The list storage section 320 associates contents identification information which identifies contents which can be issued as a comment relating to video data together with the contents title, the number of comments which can be made about that particular contents, the period over which comments can be issued, and a comment-capable video ID which is used to specify a video forming the subject about which these contents can be issued as a comment, and then stores these in a list.

A download section 321 downloads contents from the contents delivery server 5 and stores them in a contents storage section 322.

When contents which have been registered as a list are selected as a comment and the [submit] button is clicked, the transmitting section 323 transmits the selected comments together with their contents identification information to the comment delivery server 2 as comment data.

Specifically, when contents which have been registered as a list are selected as a comment, the transmitting section 323 receives the input of contents identification information for contents selected from the list storage section 320 in accordance with a selection command input via the input section 317 for video data delivered from the video delivery server 1. Next, with the elapsed video playback time at the point when the relevant contents identification information was attached as a comment taken as the comment attachment time, the transmitting section 323 transmits this to the comment delivery server 2 together with the contents identification information, the user name, the comment output method, the comment identification flag showing that the comment is in the form of contents, the video ID, and the user ID.

Moreover, when text data input via the input section 317 is input directly as a comment, the transmitting section 323 receives from the input section 317 the data input of comment contents for the video played by the video playback section 311. Next, the transmitting section 323 takes the elapsed video playback time at the point when the comment contents were input as a comment as the comment attachment time, and transmits this to the comment delivery server 2 together with the user name, the comment output method, the comment identification flag for the contents showing that the comment is in the form of text, the video ID, and the user ID.

In addition, the transmitting section 323 also has the function of transmitting various types of information and requests to the video delivery server 1, the comment delivery server 2, and the contents delivery sever 5 in accordance with commands input via the input section 317.

Next, an operation of the above described comment delivery system will be described. Here, descriptions will be given sequentially of operations of the comment delivery server 2 and the terminal device 3. Here, a description is given of when a terminal device 3 has already accessed the comment delivery server 2 and performed login processing by inputting a user ID and password.

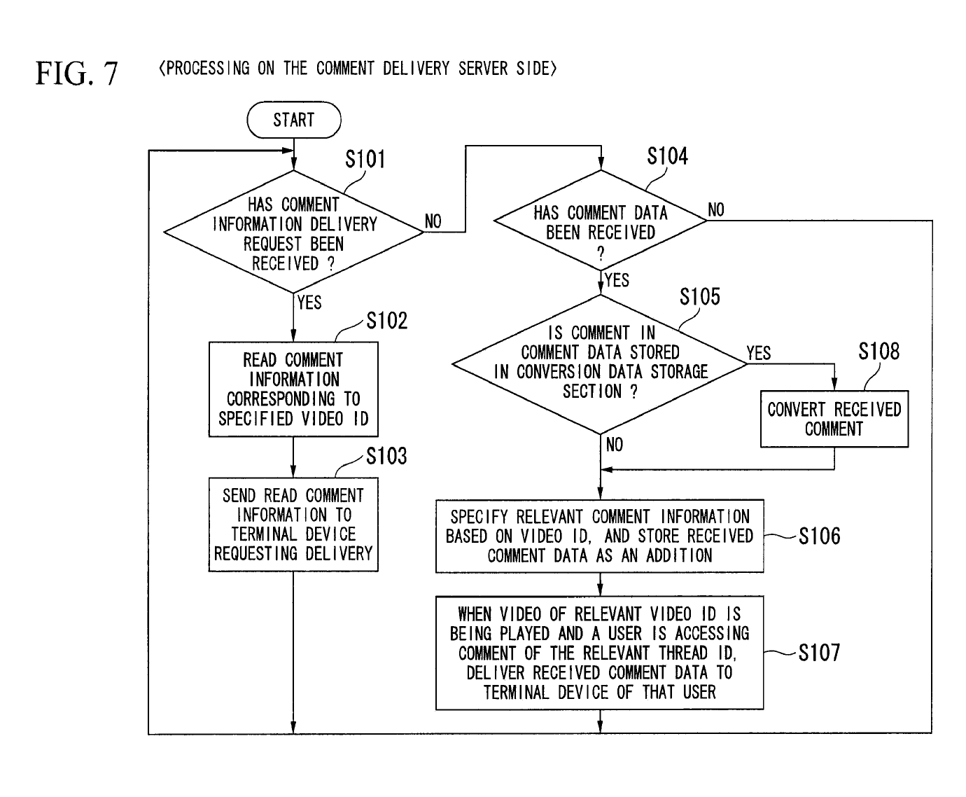

Firstly, a description will be given using the flowchart shown in FIG. 7 of an operation of the comment delivery server 2.

The communication section 22 of the comment delivery server 2 detects whether or not a comment information delivery request has been received from a terminal device 3 (step S101).

If a comment information delivery request has been received (step S101—YES), the communication section 22 outputs to the comment information delivery section 27 the video ID which is included in the delivery request. The comment information delivery section 27 reads from the comment information storage section 21 comment information which corresponds to the video ID (step S102), and transmits the read comment information to the terminal device 3 which made the delivery request (step S103). Here, the comment data included in the comment information assigned to the video ID is transmitted as a collected bundle.

If, on the other hand, in step S101 a request to deliver comment information has not been received (step S101—NO), the communication section 22 determines whether or not the comment data transmitted from the terminal device 3 has been received (step S104). If the comment data has not been received from the terminal device 3 (step S104—NO), the routines returns to step S101.

If, however, it is determined that the comment data has been received by the communication section 22 from the terminal device 3 (step S104—YES), the determination section 24 determines whether or not the comment included in the comment data is stored in the conversion data storage section 23 (step S105). If the comment included in the received comment data is stored in the conversion data storage section 23 (step S105—YES), the comment conversion section 25 converts the comment in the received comment data while referring to the conversion data storage section 23 (step S108), and proceeds to step S106).

If, however, the comment included in the received comment data is not stored in the conversion data storage section 23 (step S105—NO), the contents information control section 25 specifies the relevant comment information based on the video ID included in the received comment data, and saves the received comment data in the comment information storage section 21 as additional data (step S106). Here, if a comment is converted in step S108, then the post-conversion comment is stored.

When the additional comment data has been saved, the comment information delivery section 27 delivers this additionally saved comment data to the terminal device 3 which is accessing the comment of the comment information where the comment data has been saved as an addition (step S107).

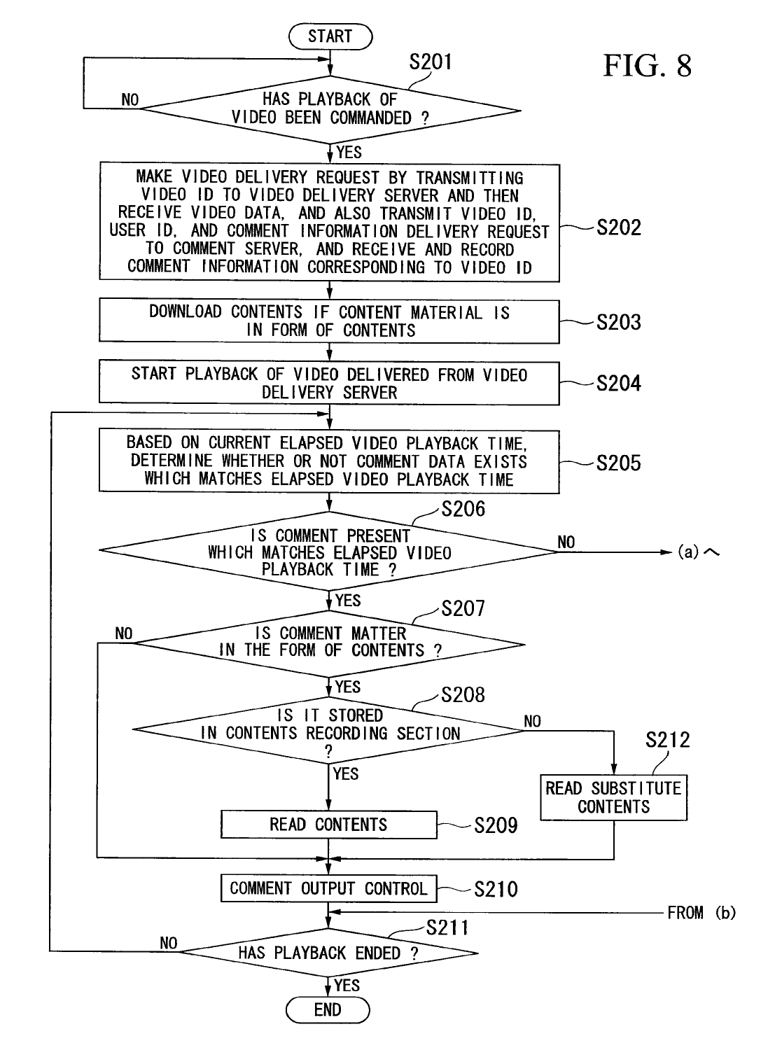

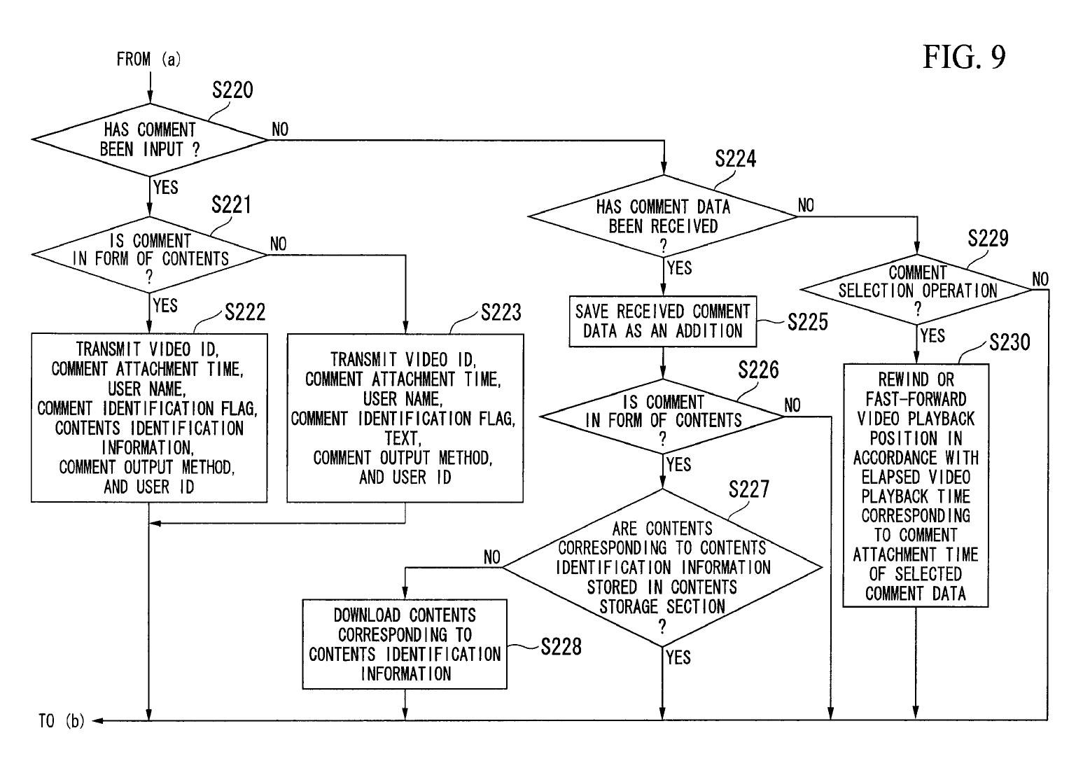

Next, an operation of the terminal device 3 will be described. FIGS. 8 and 9 are flowcharts illustrating an operation of a terminal device 3.

Firstly, in FIG. 8, when a video targeted for playback has been selected and input by a user on a menu screen via the input section 317, and the video playback command has been input (step S201—YES), the video playback section 311 of the terminal device 3 makes a video delivery request by transmitting the video ID of the commanded video to the video delivery server 1, and receives the video data. In conjunction with this, the video playback section 311 transmits the video ID, the user ID, and the comment information delivery request to the comment delivery server 2, and receives the comment information which corresponds to the video ID and stores this in the comment information storage section 313 (step S202). Here, if comment data for a text-based comment is included in the comment information, the comment data for this text, the comment attachment time, the comment actual submission time, the user name, the comment identification flag, and the comment output information are received, while if comment data for a contents-based comment is included in the comment information, then the comment attachment time, the comment actual submission time, the user name, the contents identification information stored as comment contents in the comment information, the contents title, the comment information flag, and the comment output method are received. Here, it is also possible for the received comment information to be separated into text-based comment data and contents-based comment data in accordance with the comment identification flag.

Moreover, if comment data in which the comment matter is in the form of contents is included in the received comment information, a contents delivery request is made by transmitting the contents identification information included in this comment data to the contents delivery server 5, and then downloading the contents from the contents delivery server 5 (step S203). When there is a plurality of contents, this download is performed in sequence starting from the earliest comment attachment time, namely, in sequence starting from the contents which were displayed first when video is being played back.

Next, when the download receiving time has passed a predetermined time (for example, 30 seconds), or if the download is completed by the time that contents which correspond to the comment attachment time have been output, then the terminal device 3 starts playback of the video delivered from the video delivery server 1 (step S204) and, based on the current elapsed video playback time, determines whether or not comment data exists which matches the elapsed video playback time (step S205). If comment data which matches the elapsed video playback time does exist (step S206—YES), the terminal device 3 refers to the comment-contents identification information and determines whether or not the comment is in the form of contents (step S207). If the comment is not in the form of contents (step S207—NO), then it is determined that the comment is in the form of text and the routine proceeds to step S210 where comment output control is performed. If, however, the comment matter is in the form of contents (step S207—YES), then a determination is made as to whether or not those contents are stored in the contents storage section 322 (step S208). If these contents are stored in the contents storage section 322 (step S208—YES), then the contents are read from the contents storage section 322 (step S209). Output control is then performed for the read contents (step S210).

If, however, in step S208, the contents which correspond to the contents identification information are not stored in the contents storage section 322 (step S208—NO), then substitute contents are read (step S212), and the routine moves to step S210 where the output control is performed using the substitute contents as the comment.

Next, the video playback section 311 determines whether or not the playing back of the video has ended (step S211), and if playback has ended (step S211—YES), the processing is ended, while if playback has not ended ((step S211—NO), the routine moves to step S205).

A description will now be given using the flowchart shown in FIG. 9 of the processing which is performed when, in step S206, comment data which matches the elapsed video playback time does not exist (step S206—NO).

The terminal device 3 determines whether or not a comment has been input (step S220) and if it is determined that a comment has been input (step S220—YES), the terminal device 3 determines whether or not that comment is in the form of contents (step S221). If the comment is in the form of contents (step S221—YES), the terminal device 3 transmits the video ID, the comment attachment time, the user name, the comment identification flag, the contents identification information, the comment output method, and the user ID to the comment delivery server 2 (step S222). If the comment is in the form of text (step S221—NO), the terminal device 3 transmits the video ID, the comment attachment time, the user name, the comment identification flag, the text, the comment output method, and the user ID to the comment delivery server 2 (step S223). The routine then moves to step S211.

If, however, in step S220, no comment has been input (step S220—NO), the receiving section 312 detects whether or not comment data has been received from the comment delivery server 2 (step S224). If comment data has been received (step S224—YES), the receiving section 312 saves the received comment data as additional data in the comment information storage section 313 (step S225). The receiving section 312 then refers to the comment identification flag included in the received comment data, and determines whether or not the additionally saved comment is in the form of contents (step 226). If it is not in the form of contents (step S226—NO), the routine moves to step 211.

If, however, the additionally saved comment is in the form of contents (step S226—YES), the terminal device 3 detects whether or not the contents which correspond to the contents identification information are stored in the contents storage section 322 (step S227), if they are stored in the contents storage section 322 (step S227—YES), the routine moves to step S211. If contents which correspond to the contents identification information are not stored in the contents storage section 322 (step S227—NO), then contents which do correspond to this contents identification information are downloaded from the contents delivery server 5 by the download section 321 (step S228), and the routine then moves to step S211. Here, the processing from step S211 is performed while the download is being executed.

If, however, in step S224, comment data has not been received (step S224—NO), the input section 317 determines whether or not a comment selection operation has been performed (step S229). If a comment selection operation has not been performed (step S229—NO), the routine moves to step S211. If a comment selection operation has been performed (step S229—YES), the video playback position is either rewound or fast-forwarded (step S230) in accordance with the elapsed video playback time which corresponds to the comment attachment time of the selected comment data, and the routine moves to step S211.

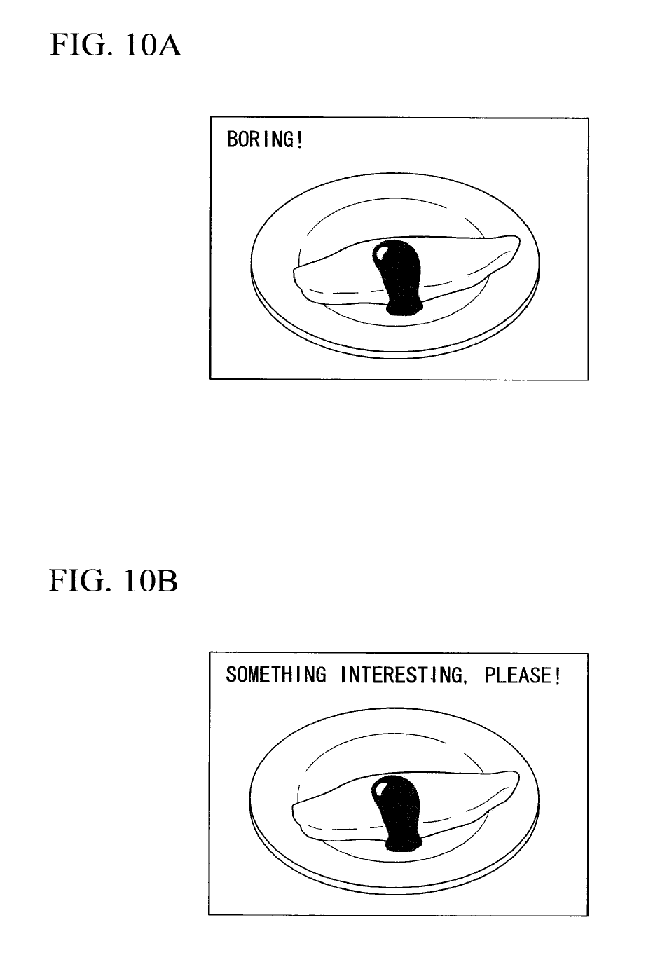

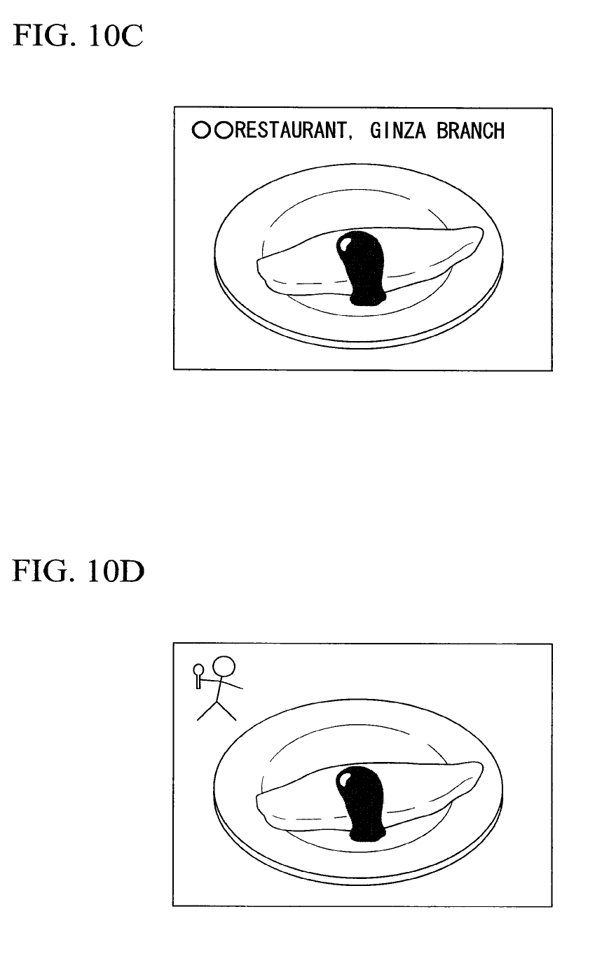

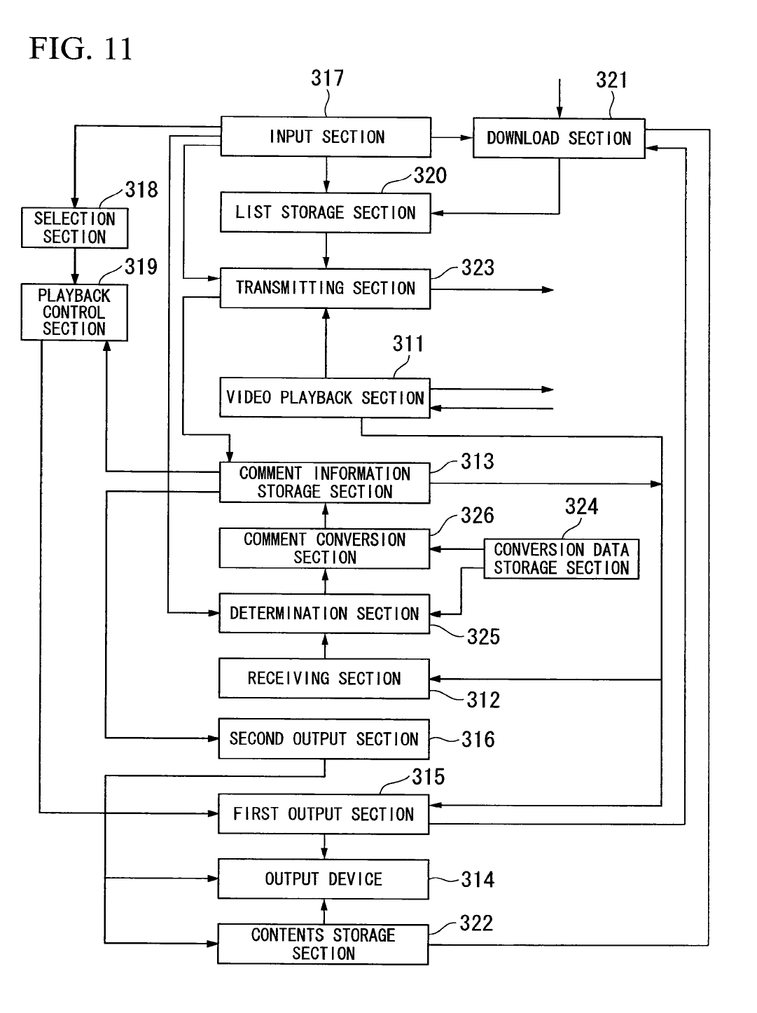

As a result of this type of processing being executed, various types of comment are output in a sequence in synchronization with the elapsed playback time of the video to the output device 314 of the terminal device 3. For example, if the comment “this is boring” is made, then if no comment conversion is performed, as is shown in FIG. 10A, the comment is displayed unedited. If, however, the above described comment conversion is performed, as is shown in FIG. 10B, the comment can be converted into, for example, “something interesting, please”, and then displayed. It is also possible for an advert for a shop providing a product which is displayed via video (FIG. 10C), or for an illustration (FIG. 10D) to be displayed. Moreover, when the comment is in audio form, audio data such as music or sound effects may be output from the output device 314 as audio.

Note that it is also possible to execute an application such as a game or the like as a comment during video playback. Moreover, a comment can also be converted into a more entertaining comment, or a more moralistic comment, or into a local dialect or the like.

In this manner, because it is possible by performing comment conversion to change a comment which is inappropriate for a particular thread or which is unappealing into another expression, it is possible to improve the level of communication and the level of entertainment. Moreover, users can enjoy anticipating what type of comment will eventuate from some comment they have contributed.

In the above described embodiment a case is described in which comment conversion is performed on the comment delivery server 2 side, however, it is also possible for a comment to be converted on the terminal device 3 side.

Next, a case in which a comment is converted in the terminal device 3 will be described. FIG. 11 is a schematic block diagram illustrating the structure of a terminal device 3 in another embodiment. In FIG. 11, portions having the same function as those described in FIG. 5 are given the same symbols as their corresponding portions in FIG. 5 and any description thereof is omitted.

A conversion data storage section 324 stores conversion data obtained by associating a comment targeted for conversion together with the comment after the targeted comment has been converted. The conversion data described in FIG. 4 can be used for this conversion data.

A determination section 325 refers to the conversion data storage section 324 and determines whether or not a comment targeted for conversion is included in the comment information received by the receiving section 312.

When it is determined based on determination results from the determination section 325 that a comment targeted for conversion is included in the comment information received by the receiving section 312, a comment conversion section 326 refers to the conversion data storage section 324 and converts the received comment into a post-conversion comment corresponding to that comment. The comment conversion section 326 then stores the comment information after the conversion in the comment information storage section 313. If a comment targeted for conversion is not stored in the received comment information, the comment information is then stored in the comment information storage section 313 without the comment being altered.

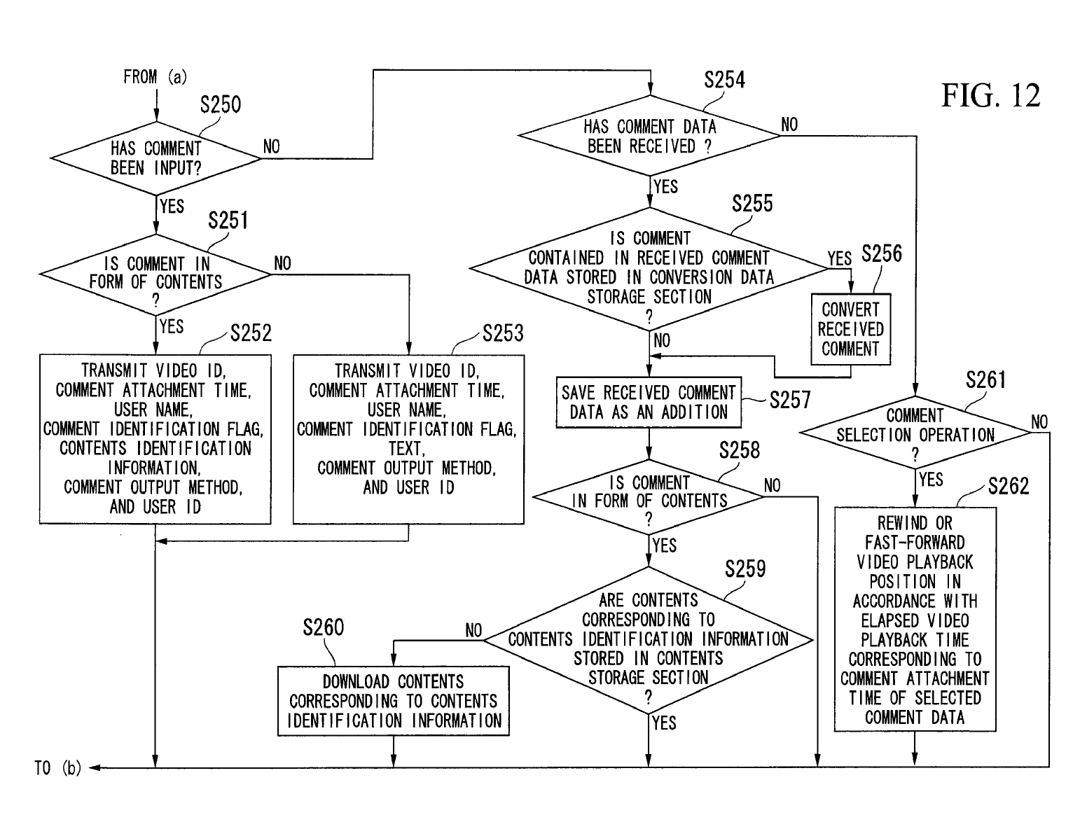

Next, an operation of the terminal device 3 having the structure shown in FIG. 11 will be described. Here, the processing of the terminal device 3 to playback video, to receive comment information from the comment delivery server 2, and to output received comment information by means of a display screen or speaker or the like is the same as that performed in step S201 through step S212 shown in FIG. 8. A case in which, in step S206 in FIG. 8, there is no comment data matching the elapsed video playback time (i.e., step S206—NO) will now be described using the flowchart in FIG. 12.

The terminal device 3 determines whether or not a comment has been input (step S250), and if it is determined that a comment has been input (step S250—YES), the terminal device 3 determines whether or not the comment is in the form of contents (step 251). If the comment is in the form of contents (step S251—YES), the terminal device 3 transmits the video ID, the comment attachment time, the user name, the comment identification flag, the contents identification information, the comment output method, and the user ID to the comment delivery server 2 (step S252). If the comment is in the form of text (step S251—NO), the terminal device 3 transmits the video ID, the comment attachment time, the user name, the comment identification flag, the text, the comment output method, and the user ID to the comment delivery server 2 (step S253). The routine then moves to step S211.

If, however, in step S250 a comment has not been input (step S250—NO), the receiving section 312 detects whether or not comment data has been received from the comment delivery server 2 (step S254). Here, if comment data has been received (step S254—YES), the receiving section 312 determines whether or not the comment in the received comment data is stored in the conversion data storage section 324 (step S255). If the received comment is stored in the conversion data storage section 324 (step S255—YES), the comment conversion section 326 converts the received comment while referring to the conversion data storage section 324 (step S256), and the routine moves to step S257.

If, however, the comment included in the received comment data is not stored in the conversion data storage section 324 (step S255—NO), the comment conversion section 326 saves the received comment data in the comment information storage section 313 as additional data (step S257). Here, if a comment was not converted in step S256, the comment data is additionally saved in an unconverted state in step S257. The comment conversion section 326 then refers to the comment identification flag included in the received comment data, and determines whether or not the additionally saved comment is in the form of contents (step S258). If it is determined that the additionally saved comment is not in the form of contents (step S258—NO), the routine moves to step S211.

If, however, it is determined that the additionally saved comment is in the form of contents (step S258—YES), the terminal device 3 detects whether or not contents which correspond to the contents identification information are stored in the contents storage section 322 (step S259). If contents which correspond to the contents identification information are stored in the contents storage section 322 (step S259—YES), the routine moves to step S211. If contents which correspond to the contents identification information are not stored in the contents storage section 322 (step S259—NO), then contents which correspond to this contents identification information are downloaded from the contents delivery server 5 by the download section 321 (step S260), and the routine moves to step S211. Here, the processing from step 211 is performed while the download is being executed.

If, however, in step S253, comment data has not been received (step S254—NO), the input section 317 determines whether or not a comment selection operation has been performed (step S261). If a comment selection operation has not been performed (step S261—NO), the routine moves to step S211. If a comment selection operation has been performed (step S261—YES), the video playback position is either rewound or fast-forwarded (step S262) in accordance with the elapsed video playback time which corresponds to the comment attachment time of the selected comment data, and the routine moves to step S211.

Note that, in the above described embodiment, a case is described in which comment conversion is not performed in the comment delivery server 2, and comment conversion is only performed on the terminal device 3 side, however, it is also possible for comment conversion to be performed respectively in both the comment delivery server 2 and the terminal device 3.

Moreover, in the above described embodiment, a case is described in which the comment targeted for conversion is in text form, however, the present invention is not limited to text comments, and it is also possible for the comment targeted for conversion to be in contents form and for the post-conversion contents to be in either text or contents form. In this case, for example, as the comment targeted for conversion shown in FIG. 4, it is possible to associate a comment identification flag which shows contents together with comment matter for which contents identification information has been set, and to then store these. In addition, if, for example, sound effects contents are issued, it is possible to determine whether or not the issued sound effects contents form a comment targeted for conversion, and if they do form a comment targeted for conversion, to then perform the comment conversion.

Moreover, in the above described embodiment, it is also possible for a user who has made a comment to delete that comment, and for users other than the user making a comment to also delete that comment. Here, the deleting of a comment can be performed, for example, by stopping it from being displayed on screen in accordance with a comment delete command input via a terminal device 3 from a user having the right to delete that particular comment. Moreover, even if users do not directly have the right to delete a comment, it is also possible for a particular comment to be displayed semi-transparently or to be stopped from being displayed if the number of comment delete requests from users without deleting rights reaches a certain level. Here, this command to delete a comment may be received by the comment delivery server 2 and the comment subsequently deleted from the comment information storage section 21, or the display method for a comment for which a delete command has been input may be set to [No display]. Alternatively, it is also possible for a comment to be set to [Semi transparent] or [Transparent] in accordance with the number of delete commands. Note that when the comment is in the form of contents, and the contents are in the form of a video or information, in the same way as for text, these contents can be set to [No display], [Semi transparent], or [Transparent], while if the contents are in the form of audio, the volume of this audio can be decreased.

As a result of the above, it is possible for a comment to be displayed after the opinion of the controller of the thread or of other users has been considered as to whether or not that comment is suitable for that particular video. Moreover, even if a user does not have sufficient rights to be able to delete a particular comment simply because they wish to, it is also possible for that comment to be deleted or displayed differently from other comments, for example, semi-transparently in accordance with the number of users. As a result, it is possible for comments to be written and deleted by a plurality of users, so that the entertainment level of a thread among users is enhanced.

Moreover, a description has been given above of when the comment display method is [normal], [semitransparent], or [transparent], however, it is sufficient if comments targeted for deleting are displayed differently from normal comments. For example, it is also possible to create multiple levels of semitransparency, or to alter the color of comments, or alter the character size, character font, or color gradation, or to show the characters as white on a colored background or the like.

Moreover, it is also possible to receive an input request from a user who has rights to delete a comment to retract a comment deletion, and for the deleted comment to be displayed again in accordance with this command.

Moreover, it is also possible to furnish users with the right to input a comment for comments made by other users. A charge may be levied on such rights in accordance with the number of times comments are issued. In addition, once a comment has been made about another particular comment, then in accordance with the content of opinions and the number of times opinions are given about that particular comment, it is possible to lower evaluation information which indicates an evaluation about a user receiving those opinions. If this evaluation information then falls below a particular standard, then irrespective of the type of comments made by that user, even if opinions from that user are in the form of specific comments (such as illustrations or pictures), they are all displayed as comments.

Moreover, it is also possible for comment data which goes back for a fixed period from a particular point in time to be extracted from comment information stored in the comment information storage section 21 of the comment delivery server 2, and for this to be stored as master comment information. Newly registered comment information may then be stored sequentially in the comment information storage section 21 as normal comment information, and when a transmission request for comment information is made from a terminal device 3, this master comment information and the normal comment information can be delivered to the terminal device 3. In the terminal device 3, the master comment information is then displayed on screen as a first layer, and the normal comment information can then be superimposed on the screen on top of this layer. Here, a system can be employed in which the master comment information cannot be deleted by anyone other than the controller or specific users or the like, while normal comment information can be deleted. As a result, previous memorable comments and opinions can be kept active, while enabling users to make further additions to those comments.

Note also that in the above described embodiment, a case is described in which the contents which are used for making a comment are obtained by the user who is making the comment downloading contents which have been prepared in advance from the contents delivery server 5 using their terminal device 3, however, it is also possible for a user to create their own original contents and upload these to the contents delivery server 5 and thereby submitting them as a comment.

At this time, the format of the uploaded contents has desirably been fixed in advance.

Note also that it is also possible to install plug-ins in terminal devices which have a function of playing video which provide them with the functions of the terminal devices 3 which they currently lack, and to thereby enable them to perform the same functions as those of the above described terminal devices 3.

Moreover, in the above described embodiments, it is also possible to perform the comment delivery control and the comment display control by recording on a computer-readable recording medium a program which realizes the functions of the comment delivery server 2 shown in FIG. 2 or a program which realizes the functions of the terminal device 3 shown in FIG. 5 and FIG. 11, and by causing this program recorded on a recording medium to be read and executed by a computer system. It is also possible for a program which realizes the functions of the terminal device 3 shown in FIG. 5 and FIG. 11 to be installed as a plug-in on an existing terminal device. Note that, here, the term ‘computer system’ includes the OS and hardware such as peripheral devices and the like.

Moreover, if a WWW system is being utilized, then ‘computer system’ can also include a homepage provider environment (or display environment).

‘Computer readable recording medium’ refers to a storage medium such as a portable medium such as a flexible disc, a magneto-optical disc, ROM, or CD-ROM, or a hard disc incorporated in a computer system or the like. Furthermore, ‘computer readable recording medium’ also includes devices that hold a program dynamically for short periods of time such as communication lines when the program is transmitted via a network such as the Internet or via a communication circuit such as a telephone line, and includes devices which hold a program for a fixed period of time such as the volatile memory incorporated in computer systems which form the servers and clients in the case of the communication lines or networks described above. The above described program may realize a portion of the above described functions or may realize the above described functions in combination with a program which has already been recorded on a computer system.

Embodiments of this invention have been described in detail above with reference made to the drawings, however, the specific structure of this invention is not limited to these embodiments and other designs and the like are also included insofar as they do not depart from the spirit or scope of this invention.

### INDUSTRIAL APPLICABILITY

The present invention can be favorably applied to a system which collect comments issued by a user and output these collected comments so as to coincide with the elapsed playback time of a video. The present invention makes it possible to change comments which are unrelated to the contents of the video or which are deemed to be inappropriate subject matter to different comments and then output the changed comments.

1. A comment delivery server in a comment delivery system comprising a video delivery server which delivers video data, the comment delivery server which delivers comments relating to the video, and a terminal device, the comment delivery server comprising:
a conversion data storage section which stores conversion data in which a comment targeted for conversion is associated with a converted comment obtained by converting the targeted comment;
a receiving section which receives as comment information from the terminal device a comment and a comment attachment time which represents an elapsed video playback time at the point when the comment is attached;
a determination section which determines whether or not the comment targeted for conversion is included in the comment information received by the receiving section in reference to the conversion data storage section;
a comment conversion section which converts the comment included in the comment information received by the receiving section into the converted comment which corresponds to the comment targeted for conversion in reference to the conversion data storage section when it is determined based on a determination result of the determination section that the comment targeted for conversion is included in the received comment information;
a comment information storage section which stores the comment information converted by the conversion section; and
a comment delivery section which delivers the comment stored in the comment information storage section to the terminal device.

2. The comment delivery server according to claim 1, wherein the conversion data storage section stores different conversion data for each item of video delivered by the video delivery server.

3. The comment delivery server according to claim 1, wherein, in the conversion data, the converted comment is any one of audio, a static image, video, and a program.

4. A terminal device in a comment delivery system comprising a video delivery server which delivers video data, a comment delivery server which delivers comments relating to the video, and the terminal device, the terminal device comprising:
a conversion data storage section which stores conversion data in which a comment targeted for conversion is associated with a converted comment obtained by converting the targeted comment;
a receiving section which receives as comment information from the comment delivery server a comment and a comment attachment time which represents an elapsed video playback time at the point when the comment is attached;
a determination section which determines whether or not the comment targeted for conversion is included in the comment information received by the receiving section in reference to the conversion data storage section;
a comment conversion section which converts the comment included in the comment information received by the receiving section into the converted comment which corresponds to the comment targeted for conversion in reference to the conversion data storage section when it is determined based on a determination result of the determination section that the comment targeted for conversion is included in the received comment information;
a comment information storage section which stores the comment information converted by the conversion section; and
an output section which outputs the comment information stored in the comment information storage section in accordance with the comment attachment time included in the comment information so as to be synchronized with the elapsed video playback time of the video data.

5. The terminal device according to claim 4, wherein the conversion data storage section stores different conversion data for each item of video delivered by the video delivery server.

6. The comment delivery server according to claim 4, wherein, in the conversion data, the converted comment is any one of audio, a static image, video, and a program.

7. The terminal device according to claim 4, wherein:
the comment delivery system comprises a contents delivery server which delivers contents;
the terminal device comprises a download section which, when a download request which commands that a download be performed is included in the comment in the comment information stored in the comment information storage section, performs a download from the contents delivery server in accordance with the download request; and
the output section outputs as a comment the contents downloaded by the download section in accordance with the comment attachment time included in the comment information so as to be synchronized with the elapsed video playback time of the video data.

8. The terminal device according to claim 4, wherein, if the download of the contents which correspond to the relevant comment attachment time is not been completed by an elapsed playback time which corresponds to the comment attachment time of the video data, the output section outputs different contents from the contents which is not yet been completely downloaded.

9. A comment delivery method in a comment delivery system comprising a video delivery server which delivers video data, a comment delivery server which delivers comments relating to the video, and a terminal device, the comment delivery method in the comment delivery server comprising:
receiving as comment information from the terminal device a comment and a comment attachment time which represents an elapsed video playback time at the point when the comment is attached;
in reference to a conversion data storage section which stores conversion data in which a comment targeted for conversion is associated with a converted comment obtained by converting the targeted comment, determining whether or not the comment targeted for conversion is included in the received comment information;
converting the comment included in the received comment information into the converted comment which corresponds to the comment targeted for conversion in reference to the conversion data storage section when it is determined based on the determination result that the comment targeted for conversion is included in the received comment information;
storing the converted comment information in a comment information storage section; and
delivering the comment stored in the comment information storage section to the terminal device.

10. A comment output method in a comment delivery system comprising a video delivery server which delivers video data, a comment delivery server which delivers comments relating to the video, and a terminal device, the comment output method in the terminal device comprising:
receiving as comment information from the comment delivery server a comment and a comment attachment time which represents an elapsed video playback time at the point when the comment is attached;
in reference to a conversion data storage section which stores conversion data in which a comment targeted for conversion is associated with a converted comment obtained by converting the targeted comment, determining whether or not the comment targeted for conversion is included in the received comment information;
converting the comment included in the received comment information into the converted comment which corresponds to the comment targeted for conversion in reference to the conversion data storage section when it is determined based on the determination result that the comment targeted for conversion is included in the received comment information;
storing the converted comment information in a comment information storage section; and
outputting the comment information stored in the comment information storage section in accordance with the comment attachment time included in the comment information so as to be synchronized with the elapsed video playback time of the video data.

11. A computer readable recording medium storing a program which causes to be executed on a computer of a comment delivery server of a comment delivery system comprising a video delivery server which delivers video data, the comment delivery server which delivers comments relating to the video, and a terminal device:
a function of receiving as comment information from the terminal device a comment and a comment attachment time which represents an elapsed video playback time at the point when the comment is attached;
in reference to a conversion data storage section which stores conversion data in which a comment targeted for conversion is associated with a converted comment obtained by converting the targeted comment, a function of determining whether or not the comment targeted for conversion is included in the received comment information;
a function of converting the comment included in the received comment information into the converted comment which corresponds to the comment targeted for conversion in reference to the conversion data storage section when it is determined based on the determination result that the comment targeted for conversion is included in the received comment information;
a function of storing the converted comment information in a comment information storage section; and
a function of delivering the comment stored in the comment information storage section to the terminal device.

12. A computer readable recording medium storing a program which causes to be executed on a computer of a terminal device of a comment delivery system comprising a video delivery server which delivers video data, a comment delivery server which delivers comments relating to the video, and the terminal device:
a function of receiving as comment information from the comment delivery server a comment and a comment attachment time which represents an elapsed video playback time at the point when the comment is attached;
in reference to a conversion data storage section which stores conversion data in which a comment targeted for conversion is associated with a converted comment obtained by converting the targeted comment, a function of determining whether or not the comment targeted for conversion is included in the received comment information;
a function of converting the comment included in the received comment information into the converted comment which corresponds to the comment targeted for conversion in reference to the conversion data storage section when it is determined based on the determination result that the comment targeted for conversion is included in the received comment information;
a function of storing the converted comment information in a comment information storage section; and
a function of outputting the comment information stored in the comment information storage section in accordance with the comment attachment time included in the comment information so as to be synchronized with the elapsed video playback time of the video data.
